(19) United States
(12) Patent Application Publication
(10) Pub. No.: US 2001/0014932 A1
(43) Pub. Date: Aug. 16, 2001

(54) Multi-processor system

(76) Inventor: Shigeru Suganuma, Tokyo (JP)

Correspondence Address: McGuire Woods, Tysons Corner, 1750 Tysons Boulevard, Suite 1800, McLean, VA, 22102-4215, US

(21) Appl. No.: 09/777,771

(22) Filed: Feb. 8, 2001

(30) Foreign Application Priority Data
Feb. 10, 2000 (JP) 2000-033227

(51) Int. Cl. G06F 12/14

(52) U.S. Cl. 711/152

(57) ABSTRACT

The multi-processor system of the present invention comprises: a plurality of processors; a shared memory shared by the processors; and an exclusive controller for arbitrating the use of the shared memory by the processors. The shared memory has an identifier storage region for storing an identifier indicating the last processor which has updated a block in the shared memory, and the processor which is to process data in the block in the shared memory compares its own identifier with the identifier stored in the identifier storage region, and does not refer to the shared memory but refers an exclusively usable memory of the processor when its own identifier coincides with the identifier in the identifier storage region.

### BACKGROUND OF THE INVENTION

1. Field of the Invention

The present invention relates to a multi-processor system which has a plurality of processors, and in particular, to a multi-processor system which has a shared memory which can be accessed by a plurality of processors, and exclusively usable memories provided with the respective processors.

2. Description of the Related Art

The performance of a conventional distributed and shared multi-processor system with a plurality of processors and a shared memory depends on a process for updating data in the shared memory. The accesses from the respective processors to refer to and update the shared memory requires a temporary exclusively use right to use one of small blocks into which the shared memory is divided, using exclusive control such as semaphore management or a test-and-set process.

The processor which obtains the exclusively use right to use a small block must release another small block which the processor has been exclusively used.

When referring to the shared memory, the respective processors must take into consideration the update of the data in the shared memory by the other processors. There are two methods to access to the shared memory.

According to the first method, the access to the shared memory is permitted on the assumption that the data in the shared memory has been updated.

That is, when the processors in the distributed and shared multi-processor system access the shared memory, the processors obtains the exclusively use right using the exclusive control, and then directly refers to and update the data in the shared memory. This method increases the frequency of accesses to the shared memory since the necessary information must be always read from the shared memory.

Further, since the processors cannot have the copy of the shared memory, the processors cannot utilize the fast exclusively usable memories or internal cache of the processors.

According to the second method, each processor has the copy of the shared memory, obtains the exclusively usable right, updates the data, and sends the notification of the update to the other processors.

However, the first and second methods have the following problems.

The first method increases the frequency of accesses to the shared memory since the data must be always read from the shared memory.

Further, since the processors cannot have the copy of the shared memory, the processors cannot utilize the fast exclusively usable memories or internal cashe of the processors.

The second method requires a special hardware function or a software process to send the notification of the update of the data in the shared memory.

Further, even when the data is repeatedly updated in the same small block in the shared memory, each update process requires the update notification.

### BRIEF SUMMARY OF THE INVENTION

It is therefore an object of the present invention to provide a system, a method, and a storage medium which provide the efficient processes of the processors in the multi-processor system, and which make efficient use of the shared memory

The multi-processor system of the present invention comprises: a plurality of processors; a shared memory shared by the processors; and an exclusive controller for arbitrating the use of the shared memory by the processors. The shared memory has an identifier storage region for storing an identifier indicating the last processor which has updated a data block in the shared memory, and the processor which is to process data in the data block in the shared memory compares its own identifier with the identifier stored in the identifier storage region, and does not refer to the shared memory but refers an exclusively usable memory of the processor when its own identifier coincides with the identifier in the identifier storage region.

The system of the present invention allows the reference to and update of the shared memories on a small block basis which are commonly accessed by a plurality of processors. Each small block has the identifier storage region for storing the identifier indicating the processor which has last updated the shared memory.

When accessing the small block, the processor refers to the identifier storage region of the block, and determines whether this processor has last updated the block. When this processor has last updated the block, the processor does not refer to the shared memory, but refers to the exclusive usable memory of the processor, or a cache memory in this processor.

The system comprises a plurality of processors (3, 4) having special identifiers, shared memories (1, 2), exclusive controllers (11, 21) for providing exclusive control for arbitrating the processes in the shared memories by the respective processors. The storage region of each of the shared memories is divided into a plurality of blocks (121, 122, . . . , 221, 222, . . . ), and the respective blocks have identifier storage regions (1211, 1212, . . . , 2211, 2212, . . . ) for storing the identifiers indicating the processor which has last updated the respective data blocks.

The processors (3, 4) have exclusively usable memories (32, 42) for storing copies of the blocks of the shared memories which the exclusive controllers permit the processors to use. The processor which handles the data in the block of the shared memory compares the data in the identifier storage region of the block with the identifier of the processor. When the value in the identifier storage region coincides with the identifier of the processor, the processor does not refer to the shared memory, but refers to the data stored in the exclusively usable memory of the processor.

When the identifier of the processor does not coincide with the identifier in the identifier storage region, the processor reads data from the block from the shared memory to the exclusively usable memory of the processor without any change of the identifier in the identifier storage region.

When the processor updates the data block in the exclusively usable memory of the processor, the processor writes the updated data into the block in the shared memory, and writes the identifier of the processor in the identifier storage region.

When the identifier of the processor, which obtains the exclusive use right to use the block through the exclusive controller, does not coincide with the identifier in the identifier storage region, the processor reads data from the block from the shared memory to the exclusively usable memory of the processor, and aborts the copy of the data block in the exclusively usable memory.

The multi-processor system further comprises an identifier controller (13, and 23 in FIG. 6) for instructing the processor to refer the exclusively usable memory of the processor when the identifier of the processor coincides with the identifier in the identifier storage region.

A computer program may causes the processor to execute the processes for causing the processor to compare the identifier of the processor with the identifier stored in the identifier storage region, and to refer the exclusively usable memory of the processor without referring the shared memory when the identifier of the processor coincides with the identifier in the identifier in the identifier storage region.

The computer program also causes the processor to execute the process for reading data from the block from the shared memory to the exclusively usable memory of the processor without any change of the identifier in the identifier storage region when the identifier of the processor does not coincide with the identifier in the identifier storage region,

The computer program also causes the processor to execute the process for writing the updated data into the block in the shared memory, and writing the identifier of the processor in the identifier storage region when the processor updates the data block in the exclusively usable memory of the processor.

The computer program also causes the processor to execute the process for reading data from the block from the shared memory to the exclusively usable memory of the processor, and aborting the copy of the data block in the exclusively usable memory when the identifier of the processor, which obtains the exclusive use right to use the block through the exclusive controller, does not coincide with the identifier in the identifier storage region.

The computer program may be read from a storage medium (a magnetic disc, magnetic tape, a semiconductor memory, or an optical disc such as a CD-ROM, or a DVD (Digital Versatile Disc)). The computer program may be downloaded and installed through a network from a server to a hard disc unit of the processor, may be read to the memory of the processor, and may be executed.

The present invention has the following advantages.

The first advantage is that the processes by the processors in the multi-processor system can be made efficient.

The reason for this is that each processor may have data in the shared memory while preventing the update of the data by the other processors, and that a high speed memory, such as an exclusively usable memory or cache memory, which makes the process of the processor efficient and accelerates the process, may be used.

The second advantage is that the use of the shared memory becomes efficient.

The reason for this is that, because the processor does not have to read the data from the shared memory and only have to perform the write operation, the number of accesses to the shared memory is decreased, the shared memory can be efficiently used, and the number of the data transfer through a common bus can be decreased.

### BRIEF DESCRIPTION OF THE DRAWINGS

FIG. 1 is a diagram showing the embodiment of the present invention.

FIG. 2 is a diagram for explaining the operation for referring the copy in the exclusively usable memory of the present invention.

FIG. 3 is a diagram showing the operation for preparing for the update of the small blocks of the shared memories in the embodiment of the present invention.

FIG. 4 is a diagram for explaining the operation for updating the data in the shared memory in the embodiment of the present invention.

FIG. 5 is a diagram for explaining the operation for referring the data updated by the other processor in the embodiment of the present invention.

FIG. 6 is a diagram showing the structure of the second embodiment of the present invention.

### DETAILED DESCRIPTION OF THE INVENTION

The embodiment of the present invention will be explained with reference to the drawings.

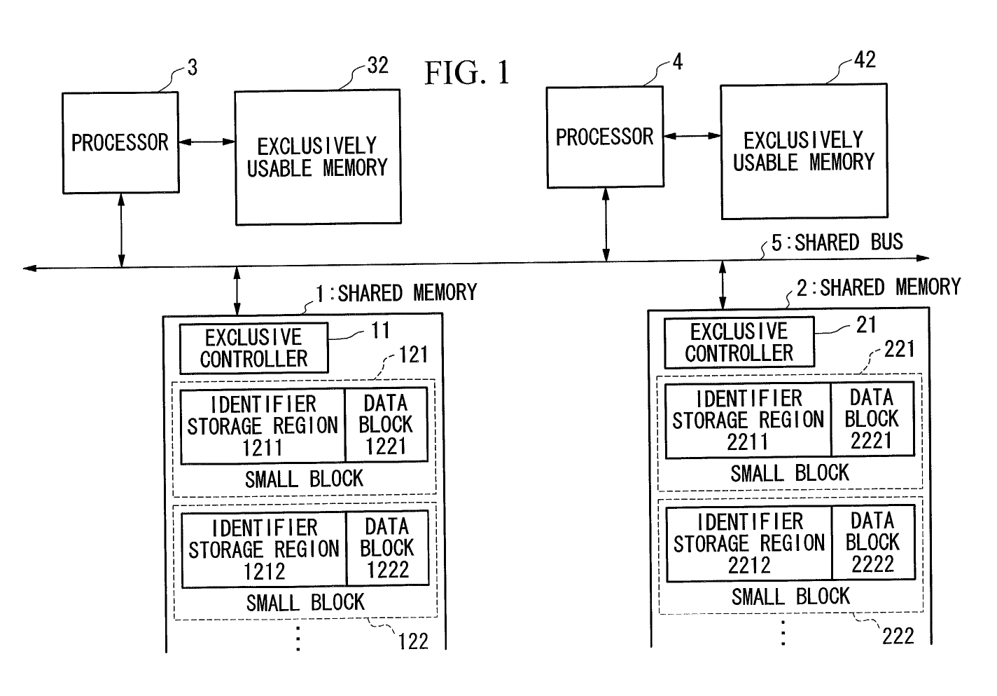

FIG. 1 is a diagram showing the system structure of the embodiment of the present invention. FIG. 1 shows a distributed and shared memory type multi-processor system which has two processors and two shared memories. The present invention is not limited to the embodiment shown in FIG. 1, and the number of the processors and the number of the shared memories are not limited.

The shared memories 1 and 2 are connected to the processors 3 and 4 through a common bus 5. The shared memories 1 and 2 have exclusive controllers 11 and 21 for arbitrating the conflict between the accesses from the processors 3 and 4.

The shared memory 1 is divided into small blocks 121, 122, . . . , and the shared memory 2 is divided into small blocks 221, 222, . . . .

The respective small blocks 121, 122, 221, and 222 have identifier storage regions 1211, 1212, 2211, and 2212 for storing the identifiers of the processors which have last updated the respective small blocks, and data blocks 1221, 1222, 2221, and 2222 for storing the actual data.

When accessing the small block, the processor 3 or 4 refers to the identifier storage region of the block, and determines whether this processor has last updated the block. When this processor has last updated the block, the processor does not refer to the shared memory 1 or 2, but refers to an exclusive usable memory of the processor 32 or 42.

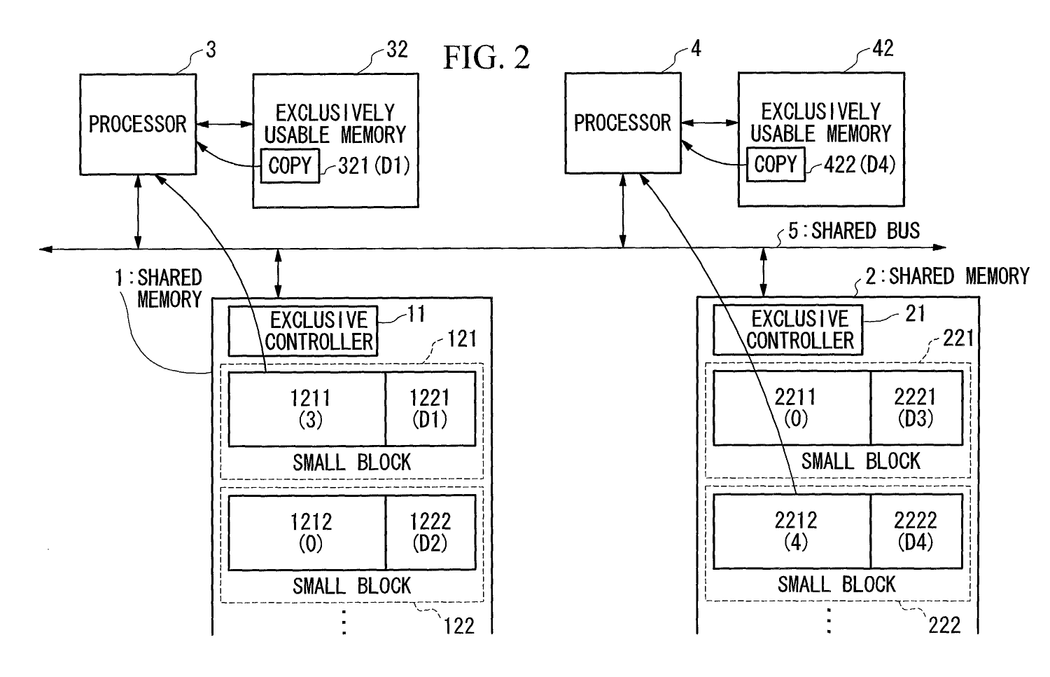

FIG. 2 is a diagram for explaining the operation of the embodiment of the present invention shown in FIG. 1. In FIG. 2, the identifier storage region 1211 of the small block 121 stores the identifier (3) indicating the processor 3. Numerals are employed as the identifiers of the processors as examples, and the identifiers (IDs) of the processors are not limited to numerals.

When the processor 3 refers to the small block 121, the processors 3 obtains the exclusively use right to use the small block 121 by means of the exclusive controllers 11, and then refers to the identifier storage region 1211.

Because the identifier (3) has been written in the identifier storage region 1211, the processor 3 does not refer to the data block 1221 of the shared memory 1, but refers to a copy 321 in the exclusively usable memory 32. The data block 1221 of the shared memory 1 and the copy 321 of the exclusively usable memory 32 have the same data (D1).

After the completion of the process, the processor 3 releases the small block 121 by means of the exclusive controller 11. This releasing process does not change the data (3) in the identifier storage region 1211.

Similarly, the identifier storage region 2212 of the small block 222 stores the identifier (4) indicating the processor 4. When the processor 4 refers to the small block 222, the exclusive controller 21 obtains the exclusive use right of the small block 222, and then refers to the identifier storage region 2221.

Because the identifier (4) has been written in the identifier storage region 2221, the processor 4 does not refer to the data block 2222, but refers to a copy 422 in the exclusively usable memory 42. The data block 2222 of the shared memory 2 and the copy 422 of the exclusively usable memory 42 have the same data (D4).

After the completion of the process, the processor 4 releases the small block 222 by means of the exclusive controller 21. This releasing process does not change the data (4) in the identifier storage region 2221.

In FIG. 2, the data (0) in the identifier storage regions 1212 and 2211 indicates that no processor has been updated the small block.

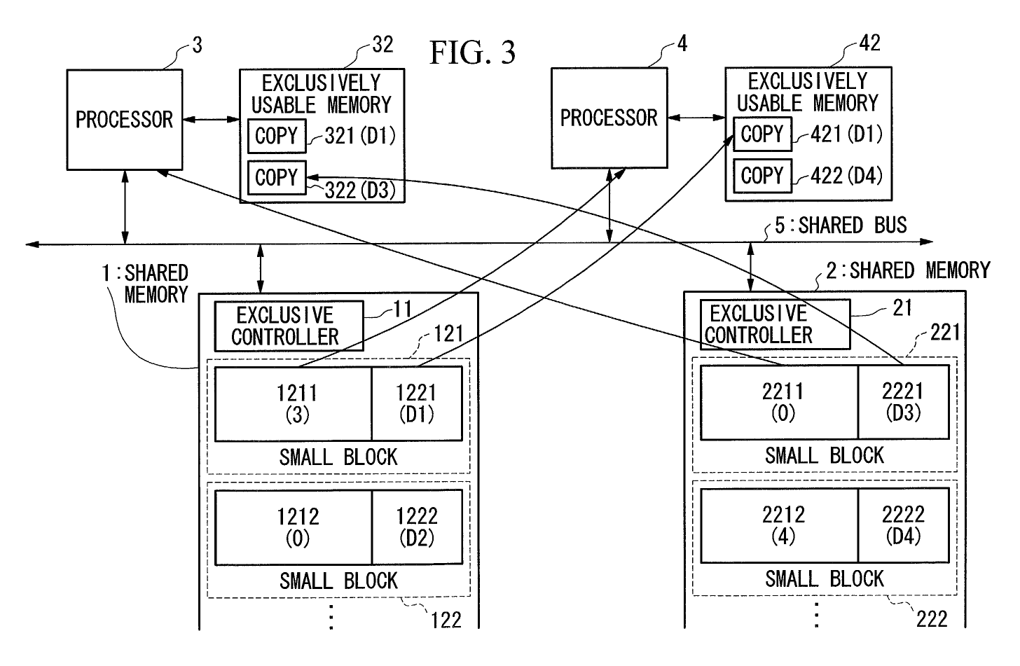

FIG. 3 is a diagram showing the operation for preparing for the update of the small blocks of the shared memories.

Referring to FIG. 3, the processor 3 obtains the exclusive use right to use the small block 221 using the exclusive controller 21 of the shared memory 2.

Then, the processor 3 refers to the identifier storage region 2211, and compares the identifier with its own identifier. In this case, the value in the identifier storage region 2211 which is (0) does not coincide with the identifier of the processor 3.

Therefore, the processor 3 reads the data from the data block 2221 in the small block 221 of the shared memory 2, and produces its copy 322 in the exclusive usable memory 32. The data block 2221 of the shared memory 2 and the copy 322 in the exclusively usable memory 32 have the same data (D3).

Similarly, the processor 4 obtains the exclusive use right to use the small block 121 using the exclusive controller 11 of the shared memory 1. Then, the processor 4 refers to the identifier storage region 1211, and compares the identifier with its own identifier. In this case, the value in the identifier storage region 1211 which is (3) does not coincide with the identifier of the processor 4. Therefore, the processor 4 reads the data from the data block 1221 in the small block 121 of the shared memory 2, and produces its copy 421 in the exclusive usable memory 42. The data block 1221 of the shared memory 1 and the copy 421 in the exclusively usable memory 42 have the same data (D1).

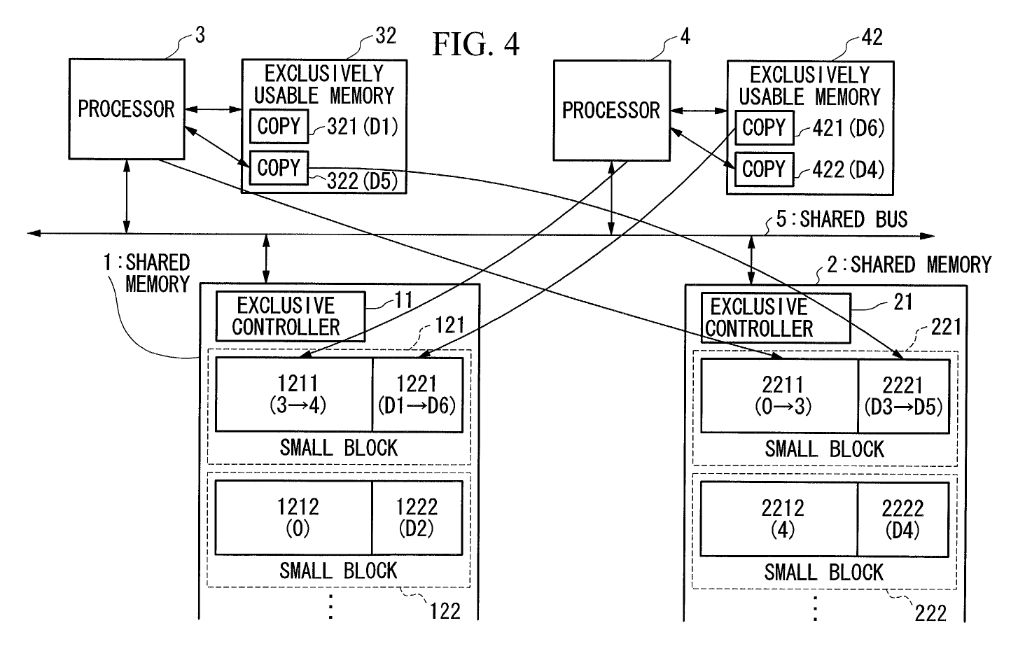

FIG. 4 is a diagram showing the operation of the processor for updating the small block of the shared memory in the embodiment shown in FIG. 1.

Referring to FIG. 4, the processor 3 has obtained the exclusive use right to use the small block 221 using the exclusive controller 21 of the shared memory 2. The processor 3 writes the data (D5) into the copy 322 in the exclusively usable memory 32.

Then, the processor 3 writes its own identifier (3) in the identifier storage region 2211 in the small block 221 of the shared memory 2.

Then, the processor 3 copies the data (D5) from the copy 322 in the exclusively usable memory 32 into the data block 2221 of the small block 221 of the shared memory 2.

Finally, the exclusive controller 21 releases the small block 221 of the shared memory 2.

Similarly, referring to FIG. 4, the processor 4 has obtained the exclusive use right to use the small block 121 using the exclusive controller 11.

The processor 4 writes the data (D6) into the copy 421 in the exclusively usable memory 42.

Then, the processor 4 writes its own identifier (4) in the identifier storage region 1211 in the small block 121 of the shared memory 1.

Then, the processor 4 copies the data (D6) from the copy 421 into the data block 1221 of the small block 121 of the shared memory 1.

Finally, the exclusive controller 11 of the shared memory 1 releases the small block 121 of the shared memory 1.

At that time, the copy 321 in the exclusively usable memory 32 of the processor 3 does not change.

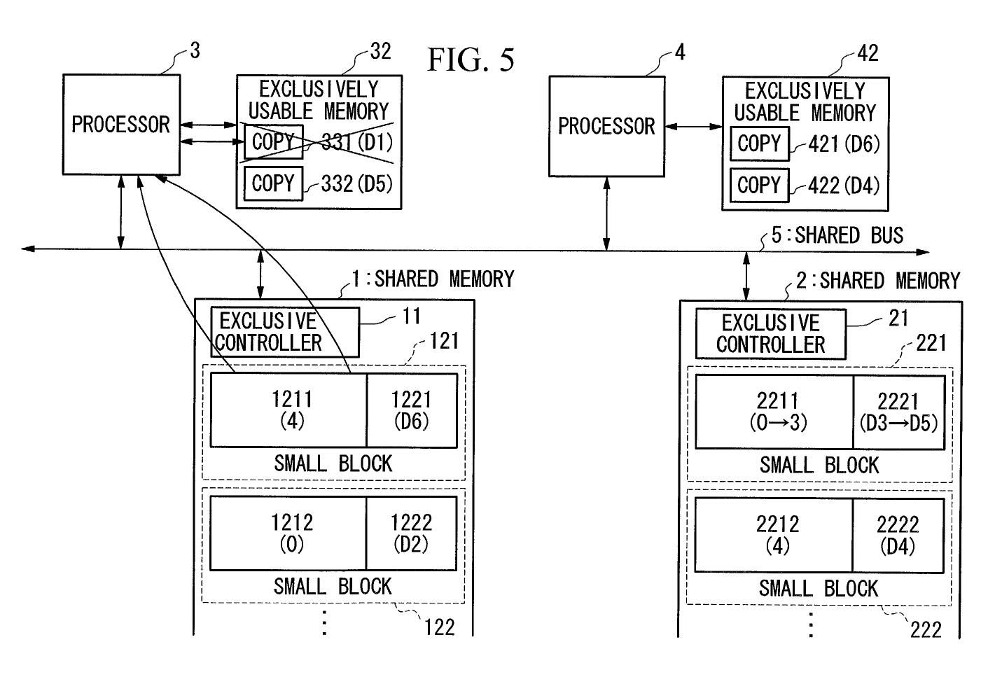

FIG. 5 is a diagram showing the operation when the data in the small block is updated by different processors.

Referring to FIG. 5, the processor 3 obtains the exclusive use right ot use the small block 121 using the exclusive controller 11 of the shared memory 1, and then refers to the identifier storage region 1211. The value in the identifier storage region 1211 which is (4) does not coincide with the identifier (3) of the processor. Therefore, the processor 3 directly refers the shared memory data block 1211, and aborts the copy 321 in the exclusively usable memory 32.

The relationship between the data in the shared memory and the copy in the exclusively usable memory does not require a special mechanism or algorithm. It is sufficient that the relationship between the data in the shared memory and the data in the exclusively usable memory is one-to-one correspondence.

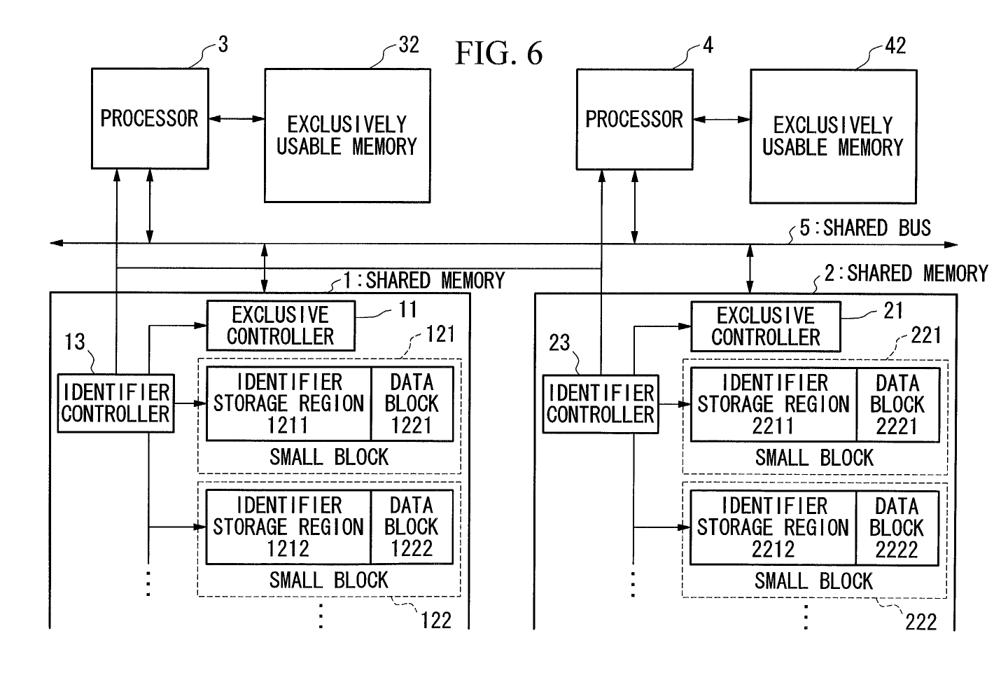

The second embodiment of the present invention will be explained. FIG. 6 is a diagram showing the structure of the second embodiment. Referring to FIG. 6, the shared memories 1 and 2 have identifier controllers 13 and 23. The identifier controllers 13 and 23 obtain the identifier of the processor which has obtains the exclusive use right to use the small block, compares the identifier with the value in the identifier storage region of the small block, and notifies the processor of the comparison result.

The processor which receives the notification determines which the processor should refer to the block data or the copy in the exclusively usable memory.

Further, the identifier controllers 13 and 23 monitor the update of the data block by the processor, and updates the value in the identifier storage region to the identifier of the processor which has updated the data block when the data block is updated.

This invention may be embodied in other forms or carried out in other ways without departing from the spirit thereof The present embodiments are therefore to be considered in all respects illustrative and not limiting, the scope of the invention being indicated by the appended claims, and all modifications falling within the meaning and range of equivalency are intended to be embraced therein.

1. A multi-processor system comprising:
a plurality of processors;
a shared memory shared by the processors; and
an exclusive controller for arbitrating the use of the shared memory by the processors, wherein
the shared memory has an identifier storage region for storing an identifier indicating the last processor which has updated a block in the shared memory, and
the processor which is to process data in the block in the shared memory compares its own identifier with the identifier stored in the identifier storage region, and does not refer to the shared memory but refers an exclusively usable memory of the processor when its own identifier coincides with the identifier in the identifier storage region.

2. A multi-processor system according to claim 2 further comprising an identifier controller for instructing the processor to refer the exclusively usable memory of the processor when the identifier of the processor coincides with the identifier in the identifier storage region.

3. A multi-processor system according to claim 1 wherein the exclusively usable memory of the processor stores a copy of the block.

4. A multi-processor system according to claim 1 wherein, when the identifier of the processor does not coincide with the identifier in the identifier storage region, the processor reads data from the block from the shared memory to the exclusively usable memory of the processor without any change of the identifier in the identifier storage region.

5. A multi-processor system according to claim 4 wherein, when the processor updates the block in the exclusively usable memory of the processor, the processor writes the updated data into the block in the shared memory, and writes the identifier of the processor in the identifier storage region.

6. A multi-processor system according to claim 3 wherein, when the identifier of the processor does not coincide with the identifier in the identifier storage region, the processor reads data from the block from the shared memory to the exclusively usable memory of the processor and aborts the copy of the block in the exclusively usable memory.

7. A computer readable medium containing program instructions for performing the steps comprising:
storing an identifier indicating a last processor which has updated a block in a shared memory;
comparing an identifier of a processor, which is to process data in the block in the shared memory, with the identifier stored in the identifier storage region; and
referring an exclusively usable memory of the processor without referring to the shared memory when its own identifier coincides with the identifier in the identifier storage region.

8. A computer readable medium according to claim 7 containing program instructions for performing the step further comprising:
instructing the processor to refer the exclusively usable memory of the processor when the identifier of the processor coincides with the identifier in the identifier storage region.

9. A computer readable medium according to claim 7 containing program instructions for performing the step further comprising:
storing a copy of the block.

10. A computer readable medium according to claim 7 containing program instructions for performing the step further comprising:
reading data from the block from the shared memory to the exclusively usable memory of the processor without any change of the identifier in the identifier storage region when the identifier of the processor does not coincide with the identifier in the identifier storage region.

11. A computer readable medium according to claim 10 containing program instructions for performing the step further comprising:
writing the updated data into the block in the shared memory, and writing the identifier of the processor in the identifier storage region, when updating the block in the exclusively usable memory of the processor.

12. A computer readable medium according to claim 9 containing program instructions for performing the step further comprising:
reading data from the block from the shared memory to the exclusively usable memory of the processor and aborting the copy of the block in the exclusively usable memory when the identifier of the processor does not coincide with the identifier in the identifier storage region.
